(19) United States
(12) Patent Application Publication
(10) Pub. No.: US 2005/0110339 A1
(43) Pub. Date: May 26, 2005

(54) EMAC arrangement for reducing wiring requirements

(76) Inventor: David A. Kolberg, Granger, IN (US)

Correspondence Address: Larry J. Palguta;Honeywell Law Department, 3520 Westmoor Street, South Bend, IN, 46628, US

(21) Appl. No.: 10/869,164

(22) Filed: Jun. 16, 2004

Related U.S. Application Data
(60) Provisional application No. 60/524,897, filed on Nov. 26, 2003.

(51) Int. Cl. B60T 13/66

(52) U.S. Cl. 303/20

(57) ABSTRACT

A brake control system for an EMA-controlled brake (60) is disclosed that includes a brake controller (66, 68), at least one serial bus (70, 72, 74, 76) running from the brake controller (66, 68), at least one EMA (32A, 32B, 32C, 32D, 32E) for actuating a brake (60), and at least one EMAC (EMAC1) having a serial bus interface (69) connected to the at least one serial bus (70, 72, 74, 76) and operatively connected to the at least one EMA (EMAC1). A method of controlling an EMA-controlled brake (60) is also disclosed.

### CROSS REFERENCE TO RELATED APPLICATIONS

The present application claims the benefit of U.S. Provisional Patent Application No. 60/524,897, filed Nov. 26, 2003, the contents of which are hereby incorporated by reference.

### FIELD OF THE INVENTION

The present invention relates to braking systems utilizing electro-mechanical actuators, and more particularly to an electro-mechanical actuator-based aircraft braking arrangement that reduces wiring requirements.

### BACKGROUND OF THE INVENTION

Braking systems using electromechanical actuators (EMAs) have been considered as alternatives to conventional hydraulic braking arrangements. In one previously disclosed aircraft braking arrangement using EMAs, a plurality of EMAs are mounted on a brake carrier housing in an annular pattern about the axis of wheel rotation. The brake carrier housing is fixed to a torque tube having stator disks of a brake disk stack attached thereto. Rotor disks of the brake disk stack, which extend between the stator disks attached to the torque tube so that rotor and stator disks alternate, are fixed to and rotatable with the wheel that rotates about an axis. The EMAs are selectively energized in response to a braking command, causing a motor-driven, reciprocating actuator piston (“ram”) to extend and engage with a pressure plate positioned on one end of the brake disk stack to compress the brake disk stack and retard wheel rotation. One EMA-based braking system is disclosed U.S. Pat. No. 6,530,625, titled “Electrically Actuated Brake With Vibration Damping,” the entire contents of which are hereby incorporated by reference.

In a conventional arrangement, the control units (EMA electronic controllers “EMACs”) are positioned in a wheel well of an aircraft, and wires for power and control are run along a landing gear strut to the EMAs. Wires on the strut are vulnerable to debris impacting against the strut and to wear from motion of the strut. This reduces the reliability of the entire braking system. An electric brake requires multiple wires per motor; with multiple motors per wheel and multiple wheels per gear, a considerable number of wires must be run along the strut. The inventor of this application found that the reliability of the braking system can be increased by reducing the number of wires that must be run along the strut.

### SUMMARY OF THE INVENTION

In accordance with a first aspect, the present invention comprises a brake control system for an EMA controlled brake that includes a brake controller and at least one serial bus running from the brake controller. At least one EMA for actuating a brake is provided and operatively connected to an EMAC having a serial bus interface which in turn is connected to the at least one serial bus.

Another aspect of the invention comprises a landing gear system that includes a strut having a proximal end connectable to an aircraft and a distal end, a truck connected to the distal end of the strut and a wheel connected to the truck. A braking system for braking the wheel, comprising at least one EMA is also provided. The braking system is controlled by a control system that includes a brake controller mountable on the aircraft, a serial bus connected to the brake controller and extending along the strut, and a first EMAC having a serial bus interface mounted on the strut or the truck and connected to the serial bus. The first EMAC controls the at least one EMA in response to a signal from the brake control unit.

A further aspect of the invention comprises a control system for controlling an EMA which system includes a brake controller mountable on an aircraft and a serial bus connected to the brake controller that extends along a movable strut having a proximal end connectable to an aircraft and a distal end. A microcontroller is mounted near the distal end of the movable strut and connected to the serial bus. The microcontroller controls the EMA in response to a signal from the brake control unit.

Another aspect of the invention comprises a system for transmitting control signals from an aircraft-mounted brake controller to an EMA of an EMA controlled aircraft brake at the distal end of a strut connected to the aircraft. The system includes a serial bus adapted to extend from the brake controller along the strut, a microcontroller mounted proximate to the distal end of the strut and a plurality of wires connecting the microcontroller to the EMA.

In a further aspect, the invention comprises a method of reducing the weight of an aircraft braking system having an EMA controlled brake that involves replacing an aircraft mounted EMAC with a truck-mounted microcontroller proximate the EMA and connecting the microcontroller to an aircraft-mounted brake controller using a serial bus.

Another aspect of the invention is useful in a brake control system for an aircraft having a wheel strut, a truck attached to the wheel strut, a wheel attached to the truck and an electromechanical-actuator-controlled brake operatively connected to the wheel. Specifically, a microcontroller is mounted on the truck, power wires and resolver wires are connected between the microcontroller and the EMA, and a serial bus is run from the microcontroller for carrying brake control signals to a brake control unit mounted on the aircraft.

An additional aspect of the invention comprise a landing gear system that includes a strut having a proximal end connectable to an aircraft and a distal end, a truck connected to the distal end of the strut, an inboard wheel having a brake connected to the truck and an outboard wheel having a brake connected to the truck. A first plurality of EMAs is provided for actuating the inboard wheel brake, and a second plurality of EMAs is provided for actuating the outboard wheel brake. First and second brake control units generate signals for controlling the actuators, and a first serial bus extends from the first brake control unit and a second serial bus extends from the second brake control unit. A first EMAC is mounted on the truck and connected to the first serial bus and to a first one of the first plurality of EMAs and to a first one of the second plurality of EMAS. A second EMAC is mounted on the truck and connected to the first serial bus and to a second one of the first plurality of EMAs. A third EMAC is mounted on the truck and connected to the second serial bus and to a third one of the first plurality of EMAs and to a second one of the second plurality of EMAs. A fourth EMAC is mounted on the truck and connected to the second serial bus and to a third one of the second plurality of EMAs.

The invention, in another aspect, comprises a method of controlling an EMA in a brake system that involves mounting a brake controller on an aircraft, providing at least one EMA mounted for actuating an aircraft wheel brake, mounting a microcontroller for controlling an EMA on an aircraft landing gear truck, running a serial bus along an aircraft landing gear strut, operatively connecting the brake controller to the serial bus, and connecting the microcontroller to the serial bus.

As described in greater detail below, an embodiment of the present invention uses micro EMACs (Electro-Mechanical Actuator Controls) that are positioned on the truck or at the distal end of the strut from an aircraft, thereby reducing the number of wires that run along the strut to the minimum necessary for redundant power and control only. In one exemplary implementation, this is typically 4 wires for power and 4 wires for control. This is compared to over 180 wires for a 4-wheel truck for the conventional braking layout. Micro EMACs placed on the truck only need power and a control bus to run down the strut and all the wires used to control each EMA are kept short, only going between the motor and the micro EMAC. A typical micro EMAC would contain one micro controller, a bus interface, and two motor drivers with sensor feedbacks. Several micro EMACs share the power and bus to keep the wires to a minimum. Redundant power and control is sent to different micro EMACs to provide drivers for the number of EMAs needed in the event of a failure in power or control.

In another aspect, an embodiment of the present invention is an electro-mechanical actuator braking arrangement having an arrangement of electro-mechanical actuator control units that enables a wiring layout with increased reliability. Other aspects of embodiments of the present invention will become evident from the following description, with reference to the appended drawings.

### BRIEF DESCRIPTION OF THE DRAWINGS

The present invention will become more fully understood from the description given below and the accompanying drawings which are given by way of illustration only, and thus do not limit the present invention and wherein:

FIG. 1 is a block diagram of an EMA-based braking arrangement used to illustrate principles of the present invention;

FIG. 2 is a rear elevational view of aircraft landing gear equipped with the braking arrangement of the present invention;

FIG. 3 is a diagram of an EMA-based braking configuration for aircraft braking in accordance with an embodiment of the present invention; and

FIG. 4 is a top plan view of an EMA controller suitable for use with the present invention.

### DETAILED DESCRIPTION

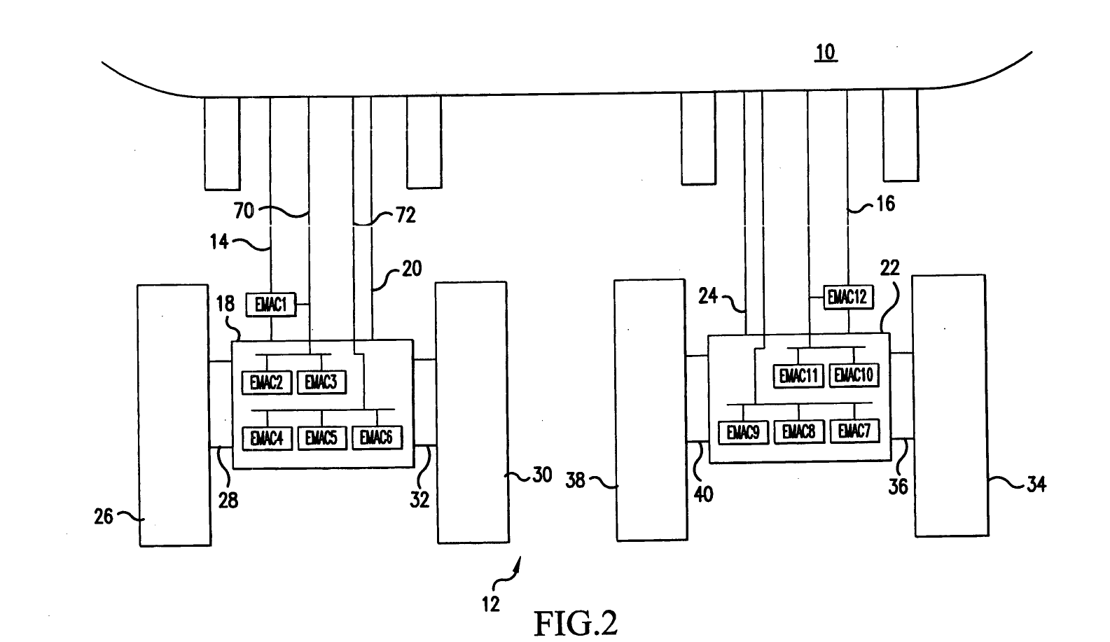

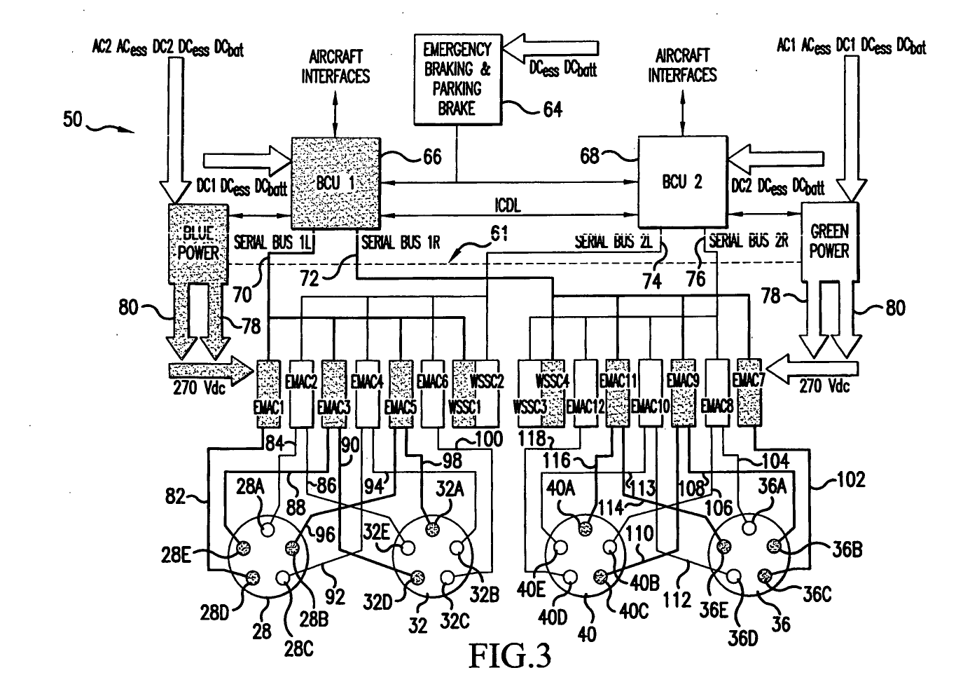

While the present invention could be used in many environments, it will be described herein in connection with an aircraft 10 such as the one shown in FIG. 2 and comprising a landing gear assembly 12 including a first strut 14 and a second strut 16, a first truck 18 attached at the distal end 20 of first strut 14 and a second truck 22 attached at the distal end 24 of second strut 16. An outboard wheel 26 is attached to first truck 18 and includes a brake carrier housing 28, and an inboard wheel 30 is attached to first truck 18 and includes a brake carrier housing 32. Second truck 22 includes an outboard wheel 34 having a brake carrier housing 36 and an inboard wheel 38 having a brake carrier housing 40. These brake carrier housings 28, 32, 36 and 40 are shown schematically in FIG. 3 without their associated wheels and landing gear elements.

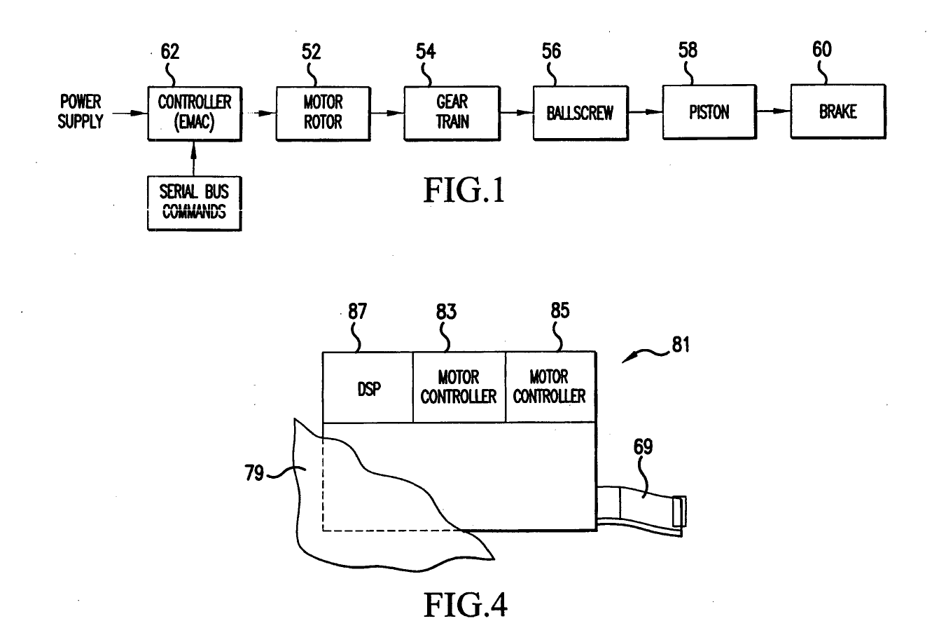

FIG. 1 is a general block diagram illustrating an EMA braking arrangement 50 to which principles of the present invention may be applied. The present invention is not limited to the number of EMA's or EMA controllers (EMAC) shown in this embodiment and will find application in many environments where at least one EMA is being controlled. Moreover, the term EMAC as used herein may comprise a single processor or multiple processors that control an EMA. As shown in FIG. 1, the EMA braking arrangement 50 of this embodiment includes: a brushless motor 52; a reduction geartrain 54 connected to the motor 52 to amplify torque; a ballnut and ball screw 56 for translating rotary motion from the geartrain 54 to linear motion; an anti-rotated piston (also referred to as “ram”) 58 connected to the ball screw 56 to provide output force and motion; and braking assembly 60 which may be, for example, a brake disk stack as described in U.S. Pat. No. 6,530,625 incorporated above by reference. The EMA braking arrangement 50 of FIG. 1 further includes a controller 62, which is also referred to herein as an EMA control (EMAC). Elements 52-58 may also be collectively referred to herein as “the EMA.”

FIG. 3 schematically shows first brake carrier housing 28, second brake carrier housing 32, third brake carrier housing 36 and fourth brake carrier housing 40, each of which includes five EMAs identified by the reference numeral of the brake carrier housing with which they are associated and a letter A through E. A given EMA, EMA 32A, for example, is selectively energized in response to a braking command, causing that EMA's piston 58 to extend and engage with a pressure plate positioned on one end of the braking assembly 60 to compress a portion of the braking assembly 60 and retard wheel rotation. The portion of FIG. 3 above dashed line 61 represents elements of the present system that are located inside aircraft 10; the portion of FIG. 3 below line 61 represents elements found outside the aircraft 10, on the landing gear system 12, for example, when the landing gear system 12 is deployed.

FIG. 3 further shows a brake actuator 64 that is manipulated by a user, a pilot in the aircraft cockpit, for example, in order to slow or stop the vehicle on which the subject braking arrangement 50 is used. Brake actuator 64 sends signals to a brake controller located in the aircraft. The brake controller may comprise a high-level aircraft control system, or as in the present embodiment, a first brake control unit 66 and a second brake control unit 68 which together control the braking assemblies on the wheels 26, 30, 34, 38 of the aircraft. These brake control units 66, 68 are mounted in the aircraft 10 in an area that may be substantially protected from the elements. While one brake control unit 66, 68 may be able to control all the EMA's of a given system, two controllers are used for redundancy. As will be described hereinafter, each of the two brake control units 66, 68 controls some of the EMAs on each wheel of the aircraft so that at least some braking force will be available if one of the brake control units fails.

First and second serial buses 70, 72 extend from first brake control unit 66 while third and fourth serial buses 74, 76 extend from second brake control unit 68. First serial bus 70 and third serial bus 74 run along first strut 14 to first truck 18 while second serial bus 72 and fourth serial bus 76 run along second strut 1 6 to second truck 22. A primary power line 78 and a back-up power line 80 also run from the aircraft along each strut.

The braking arrangement 50 described herein includes five EMAs on each braking assembly 60—a different number of actuators may be present on different systems. For this arrangement, a first set of six microcontrollers, identified as EMAC1-EMAC6, is mounted on first truck 18 or the distal end 20 of first strut 14 and a second set of microcontrollers, identified as EMAC7-EMAC12, is mounted on second truck 22 or at the distal end 24 of second strut 16. As used herein, “mounted on the truck” is intended to describe both components mounted directly on truck 18 or truck 22 as well as components mounted on an element that itself is mounted on one of the trucks, such as, but not limited to, a portion of the braking system or a portion of one of the EMA's. Each of the EMACs includes a serial bus interface and is connected to one of the serial buses 70, 72, 74, 76. Specifically, EMAC1, EMAC3 and EMAC5 are connected to first serial bus 70; EMAC7, EMAC 9 and EMAC11 are connected to second serial bus 72; EMAC2, EMAC4 and EMAC6 are connected to third serial bus 74; and EMAC8, EMAC 10 and EMAC 12 are connected to fourth serial bus 76.

According to an embodiment of the present invention, a micro EMAC is a single processor or DSP that has a high speed serial port for communication on a serial bus shared with multiple EMACs and controls one or more EMA motors. The micro EMAC is packaged to survive in the harsh environment near the aircraft wheels. One embodiment for a micro EMAC, illustrated in FIG. 4, is a small package encapsulated in epoxy 79 to protect the circuit board 81 from moisture and extreme conditions in the open environment next to the wheels. The circuit board 81 in one implementation contains pigtail connectors 69 for connection to a serial bus, such as first serial bus 70 and to input power (e.g., 270 Vdc) from one of the power lines 78, 80. Circuit board 81 further comprises a first motor controller 83 connectable to a motor in a first EMA and a second motor controller 85 connectable to a motor in a second EMA. Power may be supplied to the circuit board 81 only when braking is allowed and turned off at other times. A DSP 87 on the circuit board 81 controls the serial interface and the motors. The power supply on the circuit board 81 will convert the input power to low voltage power needed by the DSP 87 and other circuitry as well as supply the bridges for the motor control. Alternately, a separate low voltage power supply (not shown) could be provided. Each motor control may be in the form of a 3-phase power and 6 wire resolver feedback. The DSP 87 will monitor the power (current and voltage) going to the motor and provide the control necessary for advanced motion control of the motor. The DSP 87 will control the motor synchronously with sinusoidal commutation.

Each of the EMACs, EMAC1-EMAC12, are connected to one EMA or to two EMAs on separate wheels and control these actuators in response to control signals from the brake control units 66, 68. While the connections between the EMACs and the EMAs are shown as single lines in FIG. 3, each of these lines represents a plurality of wires for supplying power and controlling the motors of each EMA. This may comprise nine wires when a three phase power and six line resolver are used as described above. The following description of the connections between each EMAC and a particular one of the EMAs should be read keeping in mind that each “line” connecting the EMAC and an EMA is actually comprised of multiple wires, nine in the present example.

Each EMAC may receive commands over one of the serial buses 70, 72, 74, 76 and use embedded algorithms to drive the EMA motors to attain the commanded braking. With respect to the EMACs on first truck 18, EMAC1 is connected to EMA 28D by line 82; EMAC2 is connected to EMA 28A by line 84 and to EMA 32E by line 86; and EMAC3 is connected to EMA 28E by line 88 and to EMA 32D by line 90. Next, EMAC4 is connected to EMA 28C by line 92 and to EMA 32B by line 94. EMAC5 is connected to EMA 28B by line 96 and to EMA 32A 12. And, because the multiple wires are more protected on the truck 18, 22 than they would be exposed on one of the struts 14, 16, the opportunity for brake failure due to objects impacting against the struts 14, 16 is reduced. Moreover, only the serial buses 70, 72, 74, 76 and power lines 78, 80 run down the struts and are subject to the bending and stresses that may occur when landing gear is deployed and retracted, which further reduces damage to the control wires and making for a more reliable braking system.

The weight savings (assuming a 5 EMA system) is:

| | Baseline EMAC in | Micro EMAC |
|---|---|---|
| | Electronics Bay | Architecture |
| Wire Weight SS | 288 | 24 |
| EMAC | 75 | 60 |
| EMA/Hyd control | 340 | 340 |
| Brake Weight | 1496 | 1496 |
| Hydraulic Fluid | 16.8 | 12 |
| Total SS Weight | 2216 | −284 |

This analysis includes some additional hydraulic fluid for the increased main gear actuator due to the increased gear load.

It should be recognized that additional variations of the above-described implementations may be reached without departing from the spirit and scope of the present invention.

1. A brake control system for an EMA controlled brake comprising:
a brake controller;
at least one serial bus running from said brake controller;
at least one EMA for actuating a brake; and
at least one EMAC having a serial bus interface connected to said at least one serial bus and operatively connected to said at least one EMA.

2. The brake control system of claim 1 wherein said at least one EMA comprises first, second third EMAs.

3. The brake control system of claim 2 wherein said at least one EMAC comprises a first EMAC operatively connected to said first and second EMAs and a second EMAC operatively connected to said third EMA.

4. The brake control system of claim 1 wherein said at least one serial bus comprises a first serial bus and a second serial bus, said at least one EMA comprises a first EMA and a second EMA and said at least one EMAC comprises a first EMAC connected to said first serial bus and operatively connected to first EMA and a second EMAC connected to said second serial bus and operatively connected to said second EMA.

5. A landing gear system comprising:
a strut having a proximal end connectable to an aircraft and a distal end;
a truck connected to said distal end of said strut;
a wheel connected to said truck;
a braking system for braking said wheel comprising at least one EMA; and
a control system for controlling said at least one EMA, said control system comprising:
a brake controller mountable on the aircraft;
a serial bus connected to said brake controller and extending along said strut; and
a first EMAC having a serial bus interface mounted on said strut or said truck and connected to said serial bus, said first EMAC controlling said at least one EMA in response to a signal from said brake controller.

6. The landing system of claim 5 including a power line supplying power from the aircraft to the first EMAC.

7. The landing gear system of claim 6 wherein said first EMAC is connected to said at least one EMA by a first plurality of power wires and a second plurality of control wires.

8. The landing gear system of claim 5 wherein said at least one EMA comprises a first EMA and a second EMA operatively connected to said first EMAC.

9. The landing gear system of claim 8 including a second EMAC mounted on said strut or said truck and connected to said bus.

10. The landing gear system of claim 7 wherein each of said plurality of wires has a length and said length is less than a length of said strut.

11. The landing gear system of claim 5 wherein said first EMAC comprises a DSP and at least one motor controller.

12. The landing gear system of claim 11 wherein said EMAC is encapsulated in epoxy.

13. A control system for controlling an EMA comprising:
a brake controller mountable on an aircraft;
a serial bus connected to said brake controller and extending along a movable strut having a proximal end connectable to an aircraft and a distal end; and
a microcontroller mounted near the distal end of the movable strut and connected to said serial bus, said microcontroller controlling said EMA in response to a signal from said brake controller.

14. A system for transmitting control signals from an aircraft mounted brake controller to an EMA of an EMA controlled aircraft brake at the distal end of a strut connected to the aircraft comprising a serial bus adapted to extend from the brake controller along the strut, a microcontroller mounted proximate to the distal end of the strut and a plurality of wires connecting the microcontroller to the EMA.

15. A method of reducing the weight of an aircraft braking system having an EMA controlled brake comprising the steps of:
replacing an aircraft mounted EMAC with a truck mounted microcontroller proximate the EMA and connecting the controller to an aircraft-mounted brake controller using a serial bus.

16. In a brake control system for an aircraft having a wheel strut, a truck attached to the wheel strut, a wheel attached to the truck and an electromechanical-actuator-controlled brake operatively connected to said wheel, the improvement comprising: a microcontroller mounted on the truck, power wires and resolver wires connecting said microcontroller to the EMA and a serial bus extending from said microcontroller for carrying brake control signals to the microcontroller from a brake control unit mounted on the aircraft.

17. A landing gear system comprising:
a strut having a proximal end connectable to an aircraft and a distal end;
a truck connected to said distal end of said strut;
an inboard wheel having a brake connected to said truck;
an outboard wheel having a brake connected to said truck;
a first plurality of EMAs for actuating said inboard wheel brake;
a second plurality of EMAs for actuating said outboard wheel brake;
first and second brake control units;
a first serial bus extending from said first brake control unit and a second serial bus extending from said second brake control unit;
a first EMAC mounted on said truck and connected to said first serial bus and to a first one of said first plurality of EMAs and to a first one of said second plurality of EMAs;
a second EMAC mounted on said truck and connected to said first serial bus and to a second one of said second plurality of EMAs;
a third EMAC mounted on said truck and connected to said second serial bus and to a third one of said first plurality of EMAs and to a second one of said second plurality of EMAs;
a fourth EMAC mounted on said truck and connected to said second serial bus and to a third one of said first plurality of EMAs.

18. The landing gear system of claim 17 further including a fifth EMAC mounted on said truck and connected to said second serial bus and to a fifth one of said first plurality of EMAs and a fifth one of said second plurality of actuators.

19. The landing gear system of claim 18 further including a sixth EMAC mounted on said truck and connected to said first serial bus and to a sixth one of said first plurality of EMAs and a sixth one of said second plurality of actuators.

20. A method of controlling an EMA in a brake system comprising the steps of:
mounting a brake controller on an aircraft;
providing at least one EMA mounted for actuating an aircraft wheel brake;
mounting a microcontroller for controlling an EMA on an aircraft landing gear truck;
running a serial bus along an aircraft landing gear strut; operatively connecting the brake controller to the serial bus; and connecting the microcontroller to the serial bus.
